(19) United States
(12) Patent Application Publication
(10) Pub. No.: US 2020/0133104 A1
(43) Pub. Date: Apr. 30, 2020

(54) HINGED FILTER ATTACHMENT FOR A PHOTOGRAPHIC LENS

(71) Applicants: Jonathan MADONIA, Fountain Hills, AZ (US); Joshua KASUMOVIC, Fountain Hills, AZ (US)

(72) Inventors: Jonathan MADONIA, Fountain Hills, AZ (US); Joshua KASUMOVIC, Fountain Hills, AZ (US)

(21) Appl. No.: 16/576,318

(22) Filed: Sep. 19, 2019

Related U.S. Application Data
(60) Provisional application No. 62/749,910, filed on Oct. 24, 2018.

(51) Int. Cl. G03B 17/56; G03B 11/00

(52) U.S. Cl. CPC G03B 17/566; G03B 11/00

(57) ABSTRACT

The embodiments of the hinged filter attachment for still or video photographic lens allow a filter disc to be placed in front of a camera's lens during use, and easily pivoted away from the front of the lens when not in use. The attachment includes a first ring-shaped component that has external universal threads that mate with the standard internal threads provided on most photographic lenses. A hinge is mounted on one side of the first ring-shaped component. A second ring-shaped component is attached to the hinge and includes internal threads that mate with standard external threads provided on most photographic filter discs. In all embodiments, structure is provided to adjust and fix the rotational position of the component such that the hinge is held in a desired position relative to the top of the lens.

### BACKGROUND

### 1. Field

The disclosure of the present patent application relates to photography, and particularly to a hinged filter attachment for a photographic lens.

### 2. Description of the Related Art

Optical filters are often used in both still and video photography for various visual effects. Generally these filters are in the form of discs that are screwed onto a camera lens via a universal threading system. In order to engage or disengage these discs, they must be screwed onto or unscrewed from the lens of the camera. This is a time consuming task, that requires cessation of filming or shooting until the filter is attached or unattached from the lens. While some hinged filter attachments are available, they do not provide the ability to change the hinge position relative to the lens, such that the filter can be rotated out of the lens' line of sight, without interfering with any other attachments on the lens or camera. Furthermore, the hinges on the prior art devices can be loose, thereby allowing the filter to rotate freely as the camera is moved about, possibly partially coming into the line of sight of the camera lens, resulting in undesired results. In addition, the prior art filters allow limited torque to be applied to them when being mounted, thereby allowing movement of the filters after they have been mounted on the camera lens.

Thus a hinged filter attachment for a photographic lens solving the aforementioned problems is desired.

### SUMMARY

The non-limiting embodiments of the hinged filter attachment for still or video photographic lens allow a filter disc to be placed in front of a camera's lens during use, and easily pivoted away from the front of the lens when not in use. The attachment includes a first ring-shaped component that has external universal threads that mate with the standard internal threads provided on most photographic lenses. A hinge is mounted on one side of the first ring-shaped component and in various embodiments includes a set screw that engages the housing of the lens to fix the rotational position of the component such that the hinge is held in a desired position (angle) relative to the top of the lens. A second ring-shaped component is attached to the hinge and includes internal threads that mate with standard external threads provided on most photographic filter discs. Each component has magnets embedded therein, opposite the hinge, to keep the components in the closed position. The hinge is pre-tensioned, to hold the second ring-shaped component and the filter disc in place when the components are not in the closed position. In further embodiments, a third ring-shaped component includes the external universal threads that mate with the standard internal threads on the photographic lens. The third ring-shaped component has a frustoconical surface that mates with a frustoconical surface on the first ring-shaped component. The further embodiments allow the first and second ring-shaped components to be rotated relative to the lens, such that the rotational position of the hinge is held in a desired position (angle) relative to the top of the lens.

These and other features of the present disclosure will become readily apparent upon further review of the following specification and drawings.

### BRIEF DESCRIPTION OF THE DRAWINGS

FIG. 1A is an environmental, perspective view of a first embodiment of the hinged filter attachment for photographic lens, showing the attachment with a filter disc mounted on a lens of a camera.

FIG. 1B is an environmental, perspective, exploded view of the first embodiment of the hinged filter attachment for a photographic lens of FIG. 1, showing the attachment with a filter disc in front of the lens of the camera, to show details of the lens.

FIG. 2 is a side plan view of the first embodiment of the hinged filter attachment for a photographic lens of FIG. 1, showing the attachment in three different positions.

FIG. 3 is an environmental, perspective view of the first embodiment of the hinged filter attachment for a photographic lens of FIG. 1, illustrating the various positions in which the hinged filter attachment can be mounted on a lens of a camera.

FIG. 4A is a perspective view of the first embodiment of the hinged filter attachment for a photographic lens of FIG. 1, showing further details thereof.

FIG. 4B is an exploded perspective view of the first embodiment of the hinged filter attachment for a photographic lens of FIG. 1, showing further details thereof.

FIG. 5A is a perspective view of a first component of the first embodiment of the hinged filter attachment for a photographic lens of FIG. 1, showing further details thereof.

FIG. 5B is an exploded perspective view of the first component of the first embodiment of the hinged filter attachment for a photographic lens of FIG. 1, showing further details thereof.

FIG. 6A is a perspective view of a second component of the first embodiment of the hinged filter attachment for a photographic lens of FIG. 1, showing further details thereof.

FIG. 6B is an exploded perspective view of the second component of the first embodiment of the hinged filter attachment for a photographic lens of FIG. 1, showing further details thereof.

FIG. 7 is a perspective view of a second embodiment of a hinged filter attachment for a photographic lens, showing the attachment in a closed position.

FIG. 8 is a side plan view of the second embodiment of the hinged filter attachment for a photographic lens of FIG. 7, showing the attachment in a closed position.

FIG. 9 is a side plan view of the second embodiment of the hinged filter attachment for a photographic lens of FIG. 7, showing the attachment in an open position.

FIG. 10 is a perspective view of a third embodiment of a hinged filter attachment for a photographic lens.

FIG. 11 is a side plan view of the third embodiment of the hinged filter attachment for photographic lens of FIG. 10.

FIG. 12 is an environmental, perspective view of the third embodiment of the hinged filter attachment for a photographic lens of FIG. 10, showing the attachment with a tool in a position in front of a lens of a camera.

FIG. 13 is an environmental, perspective view of the third embodiment of the hinged filter attachment for a photographic lens of FIG. 10, showing the attachment being attached to a lens of a camera using a tool.

FIG. 14 is an environmental, perspective view of the third embodiment of the hinged filter attachment for a photographic lens of FIG. 10, showing the attachment in a first open position on a lens of a camera.

FIG. 15 is an environmental, perspective view of the third embodiment of the hinged filter attachment for a photographic lens of FIG. 10, showing the attachment in a second open position on a lens of a camera.

FIG. 16 is an environmental, perspective view of the third embodiment of the hinged filter attachment for a photographic lens of FIG. 10, showing the attachment in a third open position on a lens of a camera.

FIG. 17 is an environmental, perspective view of the third embodiment of the hinged filter attachment for a photographic lens of FIG. 10, showing the attachment in a closed position on a lens of a camera.

FIG. 18 is an enlarged, perspective view of a set screw for use with some embodiments of the hinged filter attachment for a photographic lens, showing details thereof.

FIG. 19A is an exploded side view of a fourth embodiment of the hinged filter attachment for a photographic lens.

FIG. 19B is an exploded perspective view of the fourth embodiment of the hinged filter attachment for a photographic lens of FIG. 19A.

FIG. 20A is an exploded perspective view of a fifth embodiment of the hinged filter attachment for a photographic lens.

FIG. 20B is a perspective view of the fifth embodiment of the hinged filter attachment for a photographic lens of FIG. 20A.

Similar reference characters denote corresponding features consistently throughout the attached drawings.

### DETAILED DESCRIPTION OF THE PREFERRED EMBODIMENTS

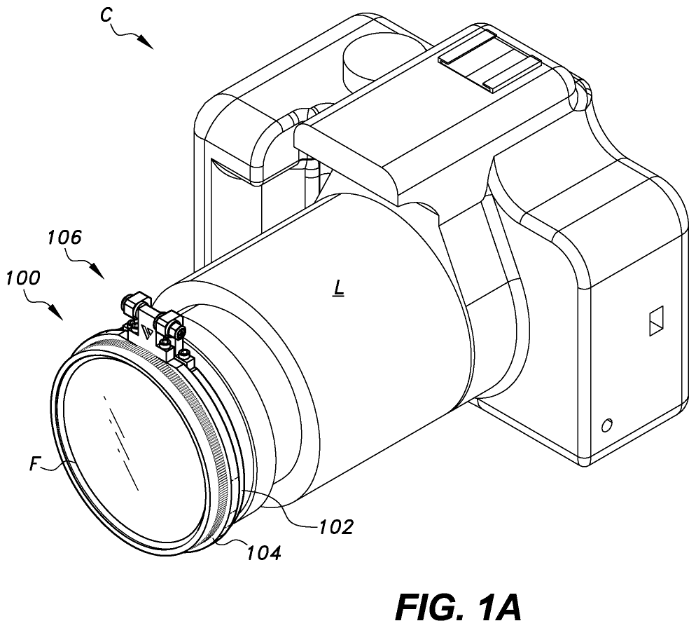

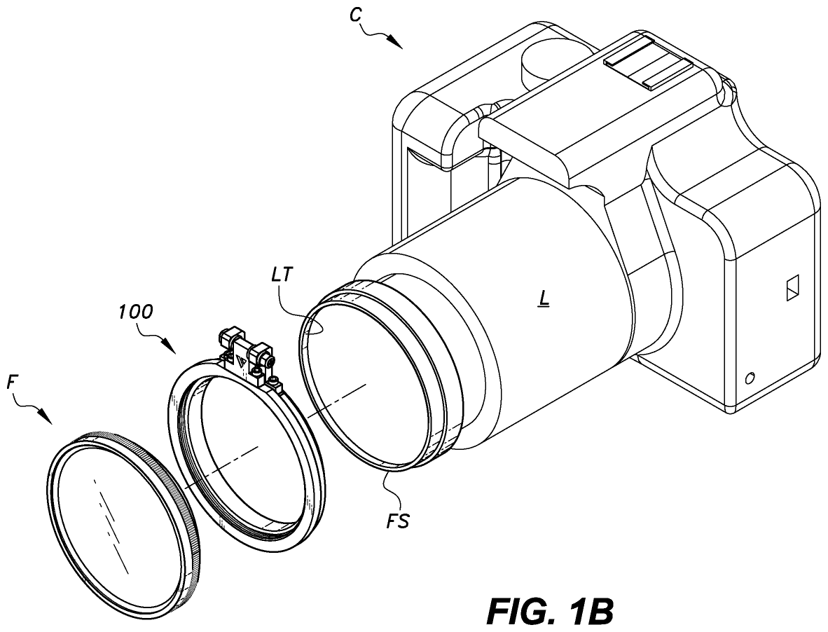

The hinged filter attachment 100 for a photographic lens is shown in FIG. 1A, mounted on a lens L of a camera C, while FIG. 1B shows an exploded view of the attachment and a filter disc in front of the lens of the camera, to show details of the lens. It should be understood that the camera C can be a still or video camera or any device that uses an optical filter disc. The attachment 100 includes a first ring-shaped component 102 that mounts on the lens L and a second ring-shaped component 104 that includes threads to mount a filter disc F. A hinge 106 is mounted on one side of the components 102 and 104 and can be positioned in any desired angle relative to the top of the lens, as described in detail below. The hinge 106 allows the second component 104 and the filter disc F, to be quickly rotated from a closed position as shown in FIG. 1, to a plurality of open positions out of the line of sight of the lens L, and visa-versa. In the closed position as shown in FIG. 1A, the filter is in use and is held in front of the lens L. Three positions of the second component 104 and the filter disc F, are shown in FIG. 2. In the first, closed position, the second ring-shaped component 104 abuts the first ring-shaped component 102 as shown in FIG. 1. In the second, open position, the second ring-shaped component 104′ and the filter disc F′, are at an angle of about 150° to the first ring-shaped component 102 and are out of the line of sight of the lens L. In the third, open position, the second ring-shaped component 104″ and the filter disc F″, are at their maximum rotation. This position depends on the relative dimensions of the hinge 106, the shape of the lens L and any other attachments to the lens L. As can be seen, in the third, fully open position, the second ring-shaped component 104″ and the filter disc F″, are at an angle of about 270° to the first ring-shaped component 102, such that the second ring-shaped component 104″ and the filter disc F″, are approximately parallel to the longitudinal axis of the lens L.

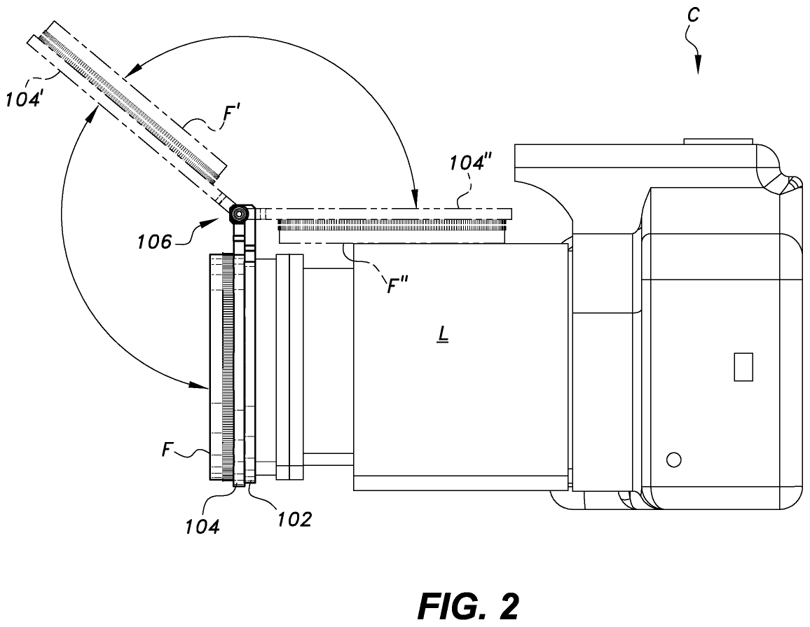

FIG. 3 illustrates the various positions in which the hinged filter attachment 100 can be mounted on the lens L of the camera C. In a first position, the hinge 106 of the hinged filter attachment 100 is positioned at the top of the lens L, such that the second ring-shaped component 104 and the associated filter disc (not shown) are rotated about an approximately horizontal axis (assuming the camera is being held horizontal). In this position, the second ring-shaped component 104 and the associated filter disc are rotated to a position above the camera lens L as shown in FIGS. 1 and 2. In a second position, the hinge 106′ of the hinged filter attachment 100′ is positioned at a point below the top of the lens L, such that the second ring-shaped component 104′ and the associated filter disc (not shown) are rotated about an axis between horizontal and vertical (again assuming the camera is being held horizontal). In this position, the second ring-shaped component 104′ and the associated filter disc are rotated to a position above and to the right of the camera lens L (from the operator's perspective behind the view finder). In a third position, the hinge 106″ of the hinged filter attachment 100″ is positioned at a point further below the top of the lens L, such that the second ring-shaped component 104″ and the associated filter disc (not shown) are rotated about an axis between horizontal and vertical (again assuming the camera is being held horizontal). In this position, the second ring-shaped component 104″ and the associated filter disc are rotated to a position below and to the right of the camera lens L (from the operator's perspective behind the view finder). This adjustability of the hinged filter attachment 100, allows the attachment to be used with various additional attachments that may be mounted on the lens L in various positions/locations.

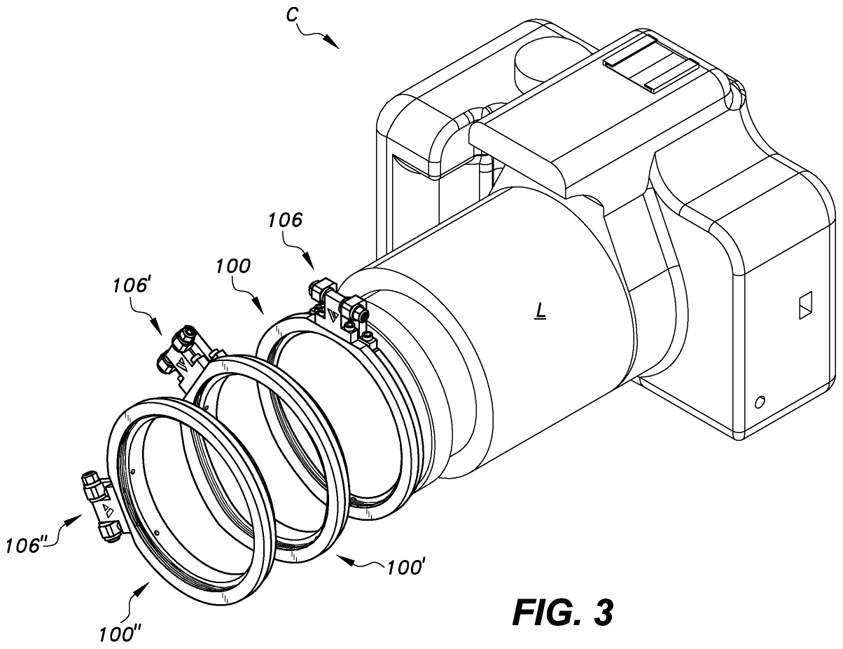

FIGS. 4A and 4B show further details of the hinged filter attachment for a photographic lens. The first ring-shaped component 102 that mounts on the lens L includes external universal threads 400 that mate with the universal internal threads (see LT in FIG. 1B) provided on most photographic lenses. The second ring-shaped component 104 includes internal universal threads 402 that mate with the universal external threads provided on most filter discs. It should be understood that the relative size, diameters and thread pitch can be matched to any particular lens and/or filter and the hinged filter attachment for a photographic lens is not limited in this respect. The term “universal” as used herein applies to any of the several thread mounts for camera lenses, provided in a variety of sizes and thread pitches. The hinge 106 includes an outer hinge element 404 that is attached to the first ring-shaped component 102 and an inner hinge element 406 that is attached to the second ring-shaped component 104. The outer hinge element 404 includes a first hinge arm 408 and a second hinge arm 410, each having a vertical through-bore 412. The inner hinge element 406 also includes a vertical through-bore 414. A hinge pin in the form of a screw 416, extends through: an upper, outer washer 418; the vertical through-bore 412 of the first hinge arm 408; an upper, inner washer 420; the vertical through-bore 414 of the inner hinge element 406; a lower, inner washer 422; the vertical through-bore 412 of the second hinge arm 410; a lower, outer washer 424; and a locknut 426. The pre-tensioned friction hinge 106 holds the second ring-shaped component in any position or angle relative to the first ring-shaped component 102. The term “pre-tensioned friction” when used to describe hinge 106, refers to the tightening of screw 416 into locknut 426 until the inner hinge element 406 is compressed between the first hinge arm 408 and the second hinge arm 410, creating friction between the various components of the hinge 106. The washers 418, 420, 422 and 424 may be plastic or metal. The locknut 426 is also metal, but includes nylon threads on its distal end 428, similar to aircraft-style locknuts.

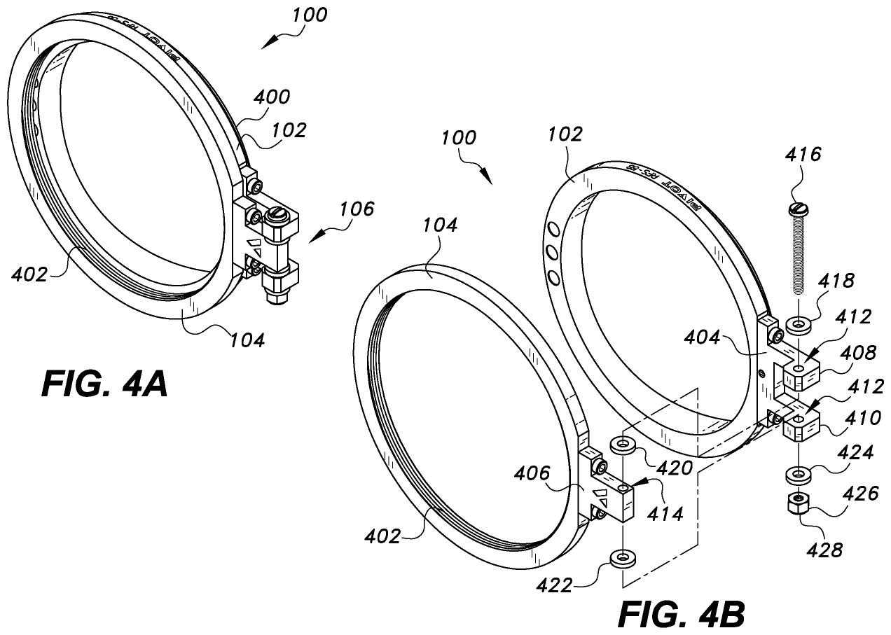

The details of the first ring-shaped component 102 of the hinged filter attachment 100 for a photographic lens are shown in FIGS. 5A and 5B. The outer edge 501 of the first ring-shaped component 102 includes a flat surface 500 on one side for attachment of the outer hinge element 404. The flat surface 500 includes an upper threaded blind bore 502 and a lower threaded blind bore 504. The outer hinge element 404 includes an upper through-bore 506 and a lower through-bore 508. A first upper hex head screw 510 extends through the upper through-bore 506 and is screwed into the upper threaded blind bore 502, while a second lower hex head screw 512 extends through the lower through-bore 508 and is screwed into the lower threaded blind bore 504, to thereby attach the outer hinge element 404 to the first ring-shaped component 102. It should be noted that when they are attached to each other the front surface 524 of the outer hinge element 404 is flush with the front surface 526 of the first ring-shaped component 102. An optional threaded set screw through-bore 514 is provided through the outer hinge element 404 at a point near to the flat surface 500. An oval-tipped set screw 516 is screwed into the threaded set screw through-bore 514 and contacts the front surface (see FS in FIG. 1B) of the lens L. The oval tip of the set screw 516 avoids damage to the front surface FS of the lens L that a pointed set screw could cause.

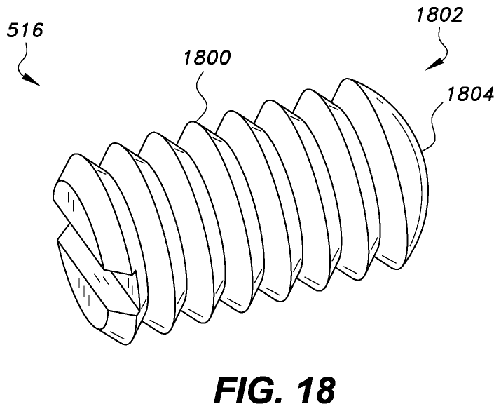

The details of the set screw 516 are shown in FIG. 18. The set screw 516 is generally cylindrical with exterior threads 1800 and does not include an increased diameter head. The end 1802 of the set screw 516 is curved in the shape of the long side of an oval, to present a rounded tip 1804 for damage-free engagement with the front surface FS (FIG. 1B) of the lens L.

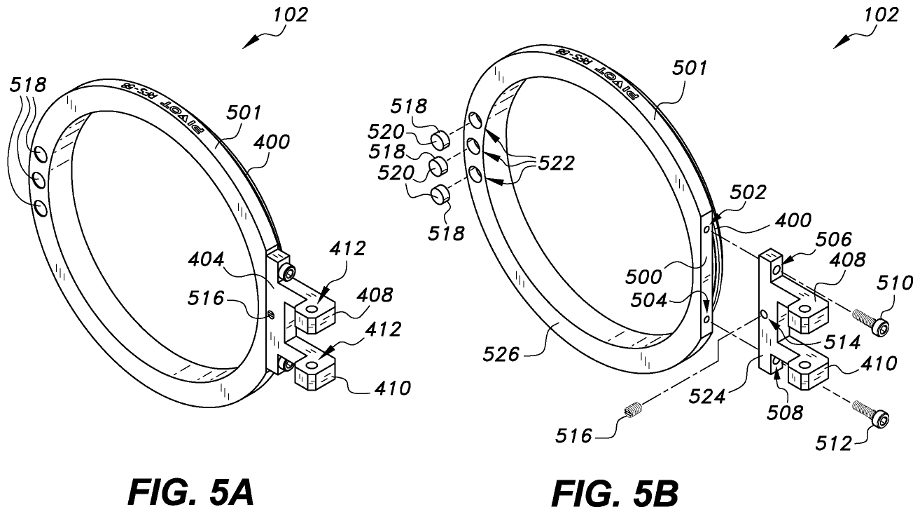

Once the hinged filter attachment 100 has been screwed onto the lens L, the set screw 516 is screwed into engagement with the front surface FS, to thereby lock the hinged filter attachment 100 into the desired position, regardless of the extent of tightening of the hinged filter attachment 100 onto the lens L. The side of the first ring-shaped component 102 opposite the outer hinge element 404, includes three disc-shaped magnets 518, mounted in blind bores 522 with their north pole sides 520 facing outwardly. The magnets 518 are attracted to magnets on the second ring-shaped component 104, to keep the hinged filter attachment 100 closed as described below with respect to FIGS. 6A-6B.

The details of the second ring-shaped component 104 of the hinged filter attachment 100 for a photographic lens are shown in FIGS. 6A and 6B. The outer edge 601 of the second ring-shaped component 104 includes a flat surface 600 on one side for attachment of the inner hinge element 406. The flat surface 600 includes an upper threaded blind bore 602 and a lower threaded blind bore 604. The inner hinge element 406 includes an upper through-bore 606 and a lower through-bore 608. A first upper hex head screw 610 extends through the upper through-bore 606 and is screwed into the upper threaded blind bore 602, while a second lower hex head screw 612 extends through the lower through-bore 608 and is screwed into the lower threaded blind bore 604, to thereby attach the inner hinge element 406 to the second ring-shaped component 104. It should be noted that when they are attached to each other the rear surface 624 of the inner hinge element 406 is flush with the rear surface 626 of the second ring-shaped component 104. The side of the second ring-shaped component 104 opposite the inner hinge element 406, includes three disc-shaped magnets 618, mounted in blind bores 622 with their south pole sides 620 facing outwardly. The magnets 618 on the second ring-shaped component 104 are attracted to the magnets on the first ring-shaped component 102, such that when the hinged filter attachment 100 is closed the magnets maintain it closed until sufficient force is applied to overcome the magnetic force between magnets 518 and 618.

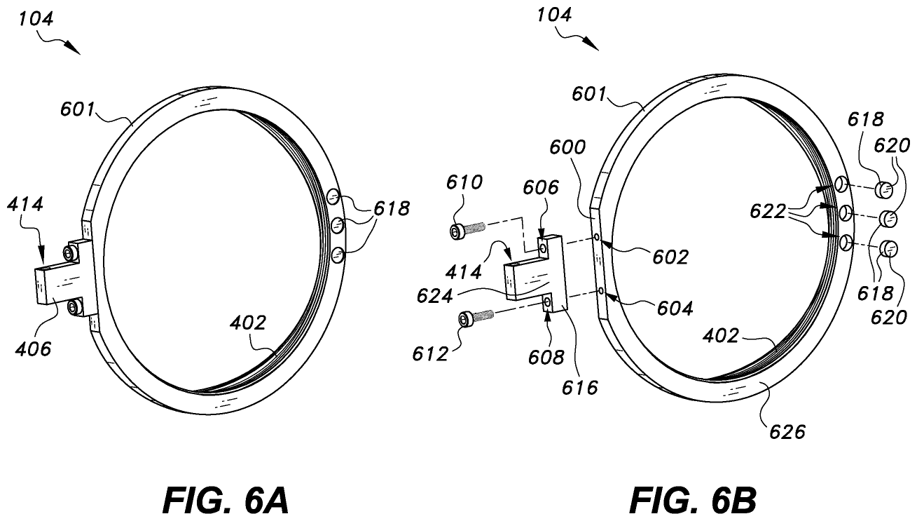

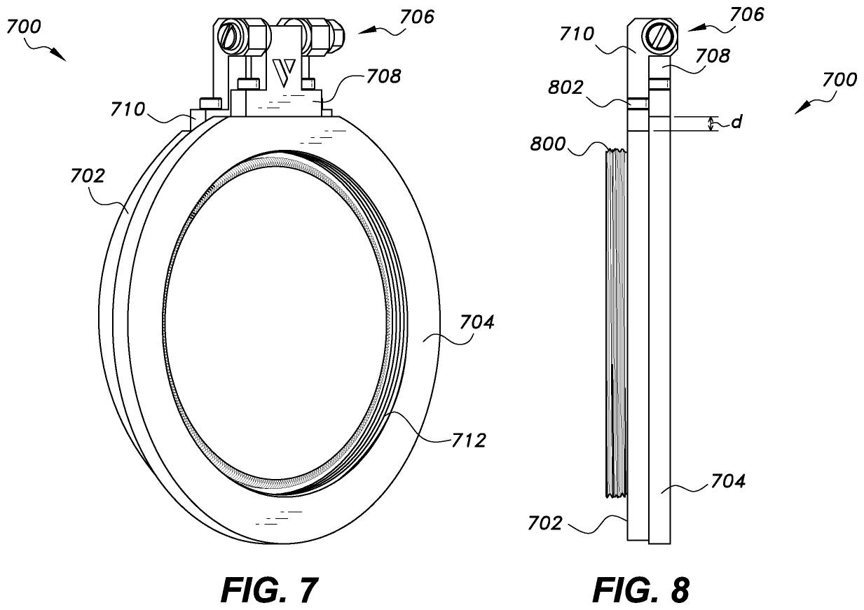

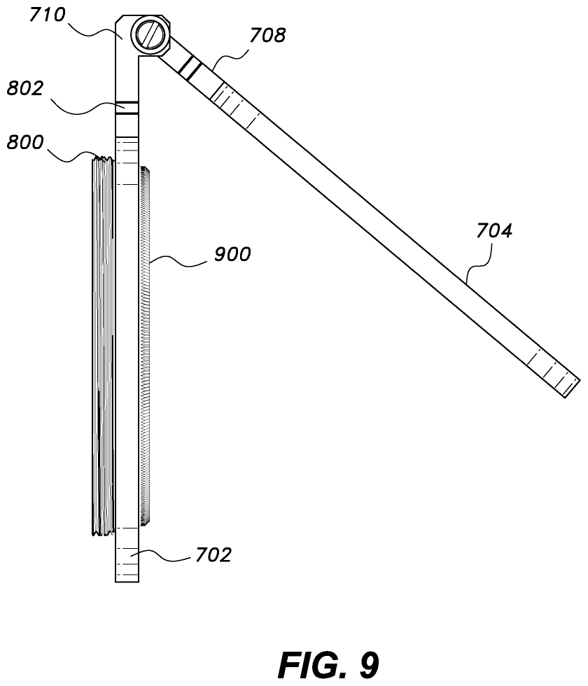

FIGS. 7-9 show a second embodiment of the hinged filter attachment for a photographic lens 700. As with the previous embodiment, the hinged filter attachment 700 includes a first ring-shaped component 702 that mounts on the lens L and a second ring-shaped component 704 that includes means to mount a filter disc F. A pre-tensioned friction hinge 706 is mounted on one side of the components 702 and 704 and can be positioned in any desired angle relative to the top of the lens, as described above with respect to the hinge 106 of the first embodiment. The hinge 706 allows the second component 704 and the filter disc F, to be quickly rotated from a closed position as shown in FIG. 7, to a plurality of open positions out of the line of sight of the lens L, and visa-versa. In the closed position as shown in FIG. 7, the filter in use and is held in front of the lens L. The second ring-shaped component 704 of the attachment 700 has a slightly larger outer diameter than the second ring-shaped component 702, to assist in handling the second ring-shaped component 704 when changing the position of the filter disc F. In order to maintain the first ring-shaped component 702 centered with respect to the second ring-shaped component 704, the inner hinge element 708 of the hinge 706 extends a distance d (FIG. 8) further than the outer hinge element 710 of the hinge 706. The second ring-shaped component 704 includes internal universal threads 712 that mate with the universal external threads provided on most filter discs. The first ring-shaped component 702 that mounts on the lens L includes external universal threads 800 that mate with the universal internal threads (see LT in FIG. 1B) provided on most photographic lens. The outer hinge element 710 of the hinge 706 includes a threaded set screw through-bore 802 for receipt of an oval-tipped set screw for purposes as described with respect to the oval-tipped set screw 516 of the first embodiment. As seen in FIG. 9, the first ring-shaped component 702 includes a light skirt 900 which prevents light from entering between the first ring-shaped component 702 and the second ring-shaped component 704 (and therefore between the camera lens L and the filter disc F), when the attachment 700 is in the closed position.

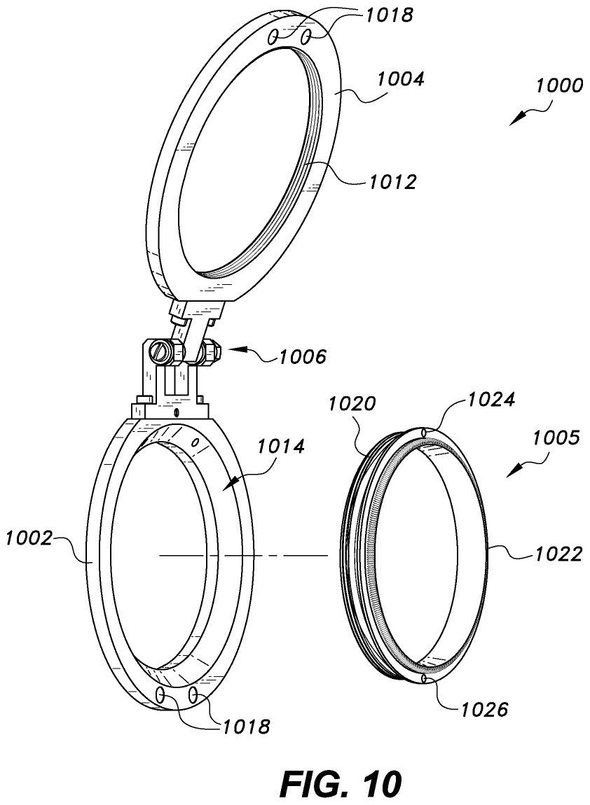

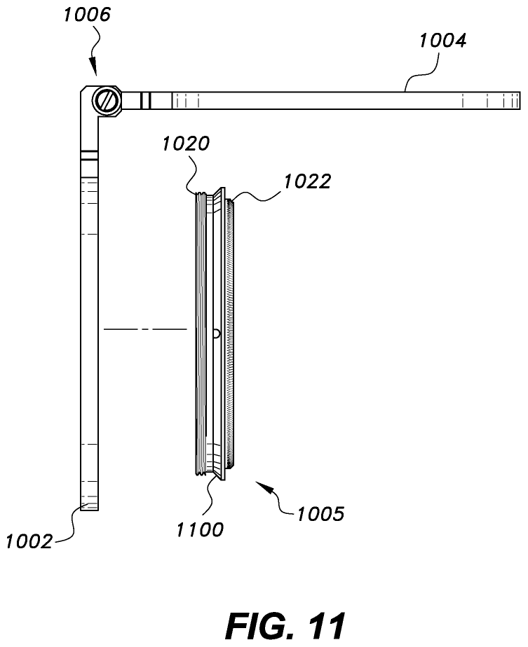

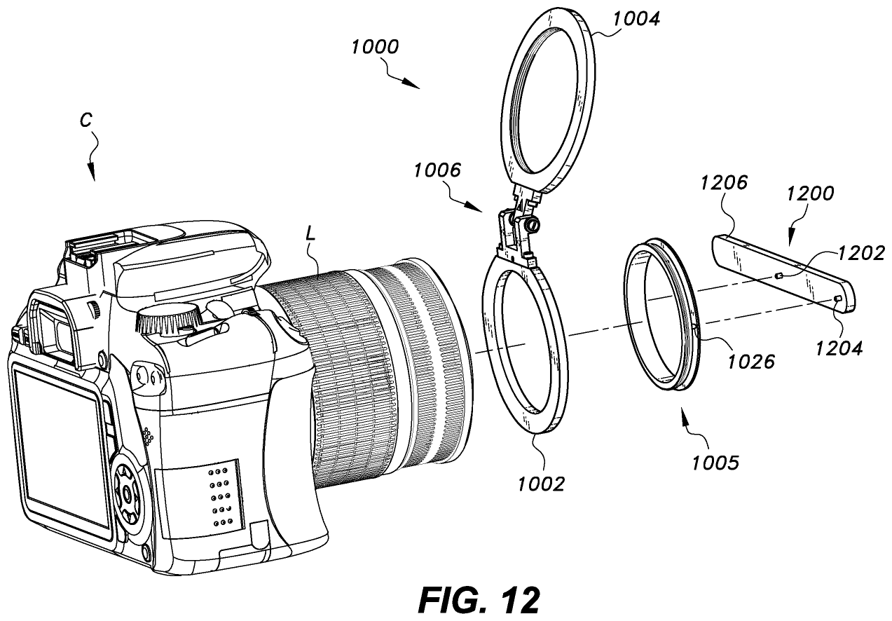

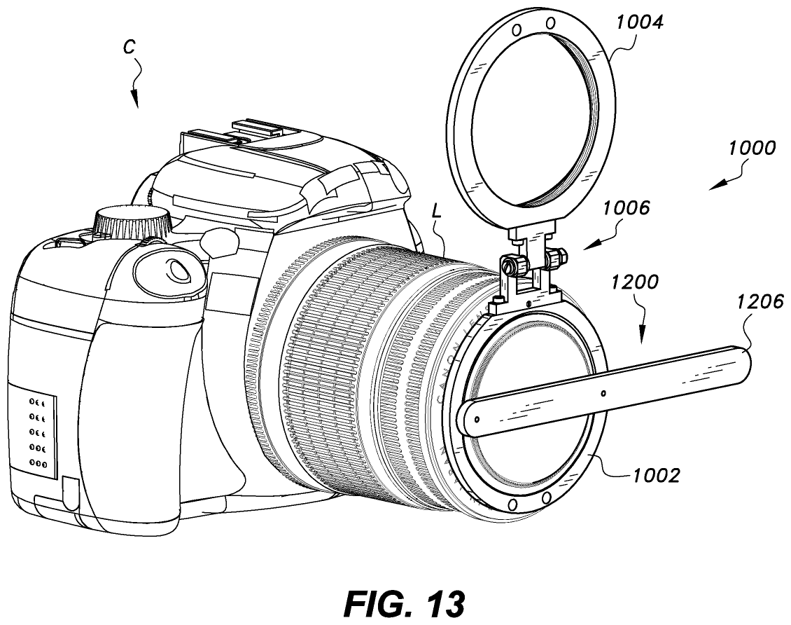

A third embodiment of the hinged filter attachment for a photographic lens 1000, is shown in FIGS. 10-17. As with the previous embodiments, the hinged filter attachment 1000 includes a first ring-shaped component 1002 that mounts on the lens L and a second ring-shaped component 1004 that includes internal universal threads 1012 that mate with the universal external threads provided on most filter discs. A pre-tensioned friction hinge 1006 is mounted on one side of the components 1002 and 1004 and can be positioned in any desired angle relative to the top of the lens, as described below. The hinged filter attachment 1000 also includes magnets 1018 for maintaining the hinged filter attachment 1000 in the closed position as described with respect to the first embodiment. The hinged filter attachment 1000 further includes a third ring-shaped component 1005 that includes external universal threads 1020 that mate with the universal internal threads (see LT in FIG. 1B) provided on most photographic lens. The third ring-shaped component 1005 also includes a convex frustoconical surface 1100 that engages a concave frustoconical surface 1014 on the first ring-shaped component 1002. To mount the hinged filter attachment 1000 to a camera lens, the third ring-shaped component 1005 is screwed onto the camera lens through the center of the first ring-shaped component 1002, until the convex frustoconical surface 1100 engages the concave frustoconical surface 1014 on the first ring-shaped component 1002. Once attached, the first ring-shaped component 1002 and the second ring-shaped component 1004 are rotated until the hinge 1006 is in the desired position. The third ring-shaped component 1005 is then tightened onto the lens to clamp the first ring-shaped component 1002 between the front surface (FS in FIG. 1B) of the lens and the convex frustoconical surface 1100 of the third ring-shaped component 1005, thereby locking it in the desired position. The third ring-shaped component 1005 also includes a light skirt 1022, which prevents light from entering between the first ring-shaped component 1002 and the second ring-shaped component 1004 (and therefore between the camera lens L and the filter disc F), when the hinged filter attachment 1000 is in the closed position. A first tool engaging bore 1024 and a second tool engaging bore 1026 are provided in the third ring-shaped component 1005, for engagement by a tool as described below with respect to FIGS. 12 and 13.

FIG. 12 shows the attachment 1000 in position to be mounted on the lens L of a camera C. Once the hinge 1006 of the attachment 1000 is in the desired position (shown here substantially at the top of the lens L), a tool 1200 is used to engage the tool engaging bores 1024 and 1026 using first 1202 and second 1204 cylindrical protrusions. The tool includes an elongate handle 1206 to provide torque when turning the third ring-shaped component 1005 to screw it onto the lens L. FIG. 13 shows the final position after the hinged filter attachment for a photographic lens 1000 has been attached to the lens L.

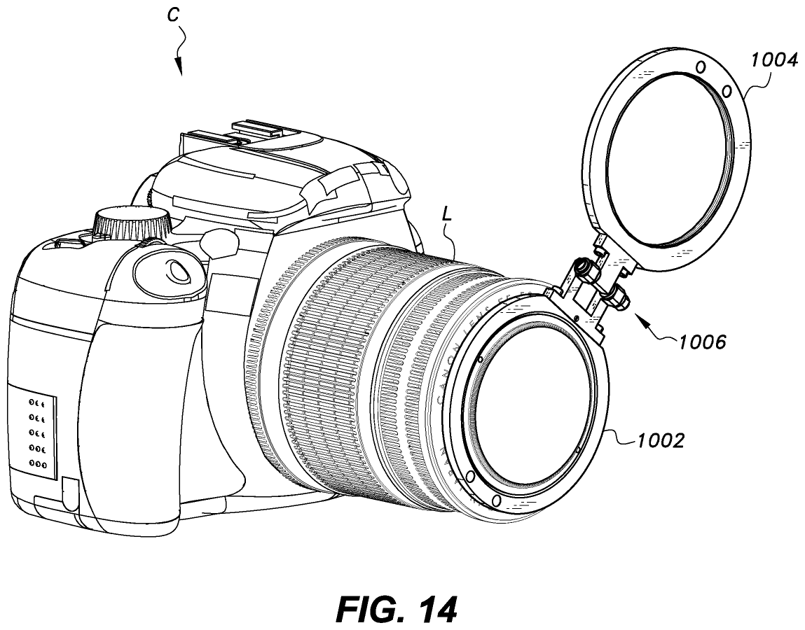

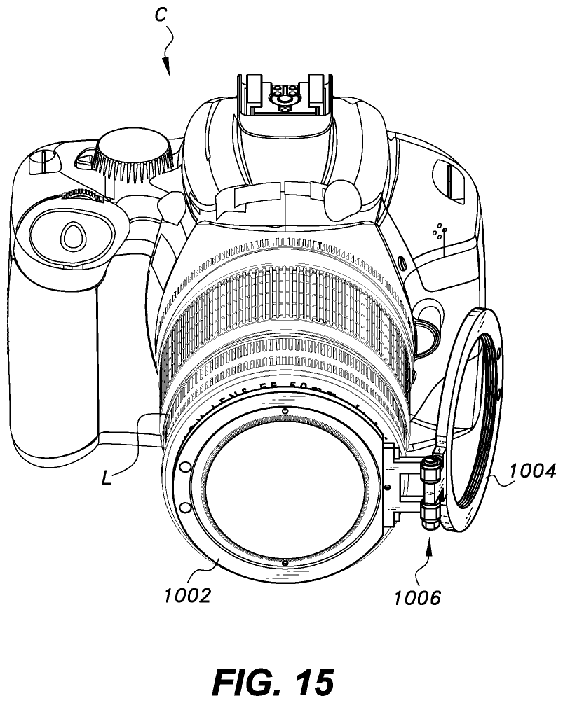

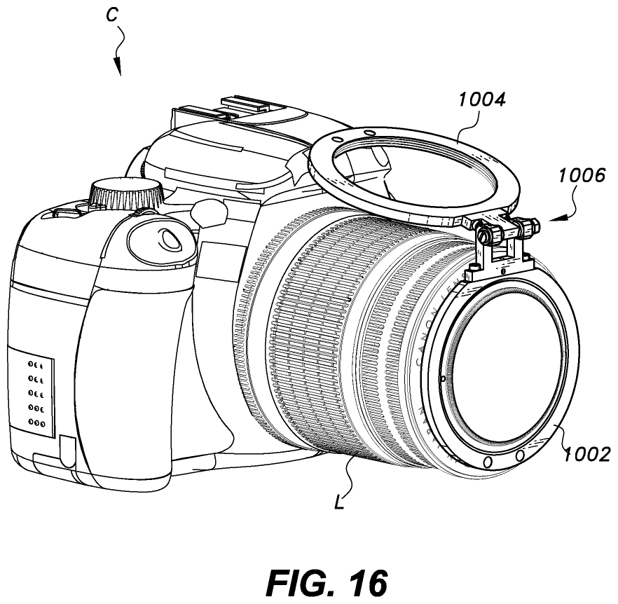

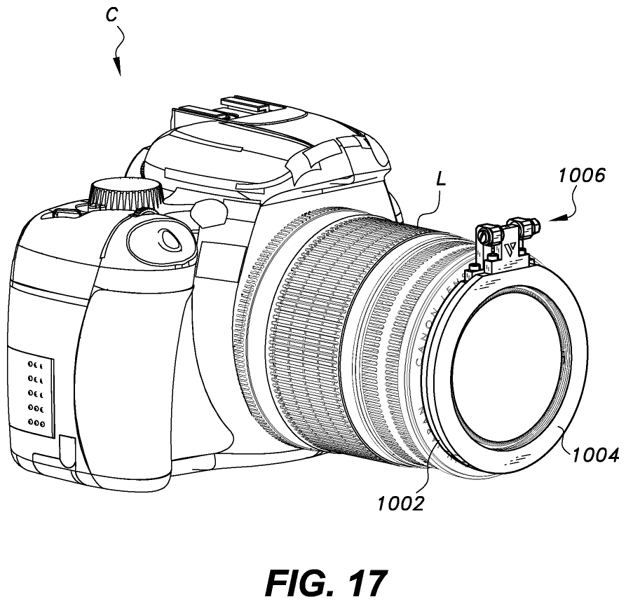

FIGS. 14-17 show various positions of the hinged filter attachment 1000 on lens L. In FIG. 14, the hinged filter attachment 1000 is mounted on the lens L such that the hinge 1006 is above and to the left of the camera lens L, (from the operator's perspective behind the view finder), such that the filter disc F is above and to the left of the camera lens L in the open position as shown. In FIG. 15, the hinged filter attachment 1000 is mounted on the lens L such that the hinge 1006 is to the left of the camera lens L, (from the operator's perspective behind the view finder), such that the filter disc F is to the left of the camera lens L in the open position as shown. In FIG. 16, the hinged filter attachment 1000 is mounted on the lens L such that the hinge 1006 is above the camera lens L, such that the filter disc F is above the camera lens L in the open position as shown. In FIG. 17, the hinged filter attachment 1000 is shown in the closed position when the hinge 1006 is above the camera lens L. While three positions of the hinge 1006 relative to the top of the lens L are shown in FIGS. 14-17, it should be understood that the hinged filter attachment 1000 can be adjusted such that the hinge 1006 can be located at any position relative to the top of the lens L. To clarify, if 0° is the top of the lens L, than the position of the hinge 1006 can be adjusted between 0° (the top of the lens L), 90° (the left of the lens) 180° (the bottom of the lens) 270° (the right of the lens) and 360° (back to the top of the lens L), and any position therebetween. Note that this is also true for the other embodiments of the hinged filter attachment.

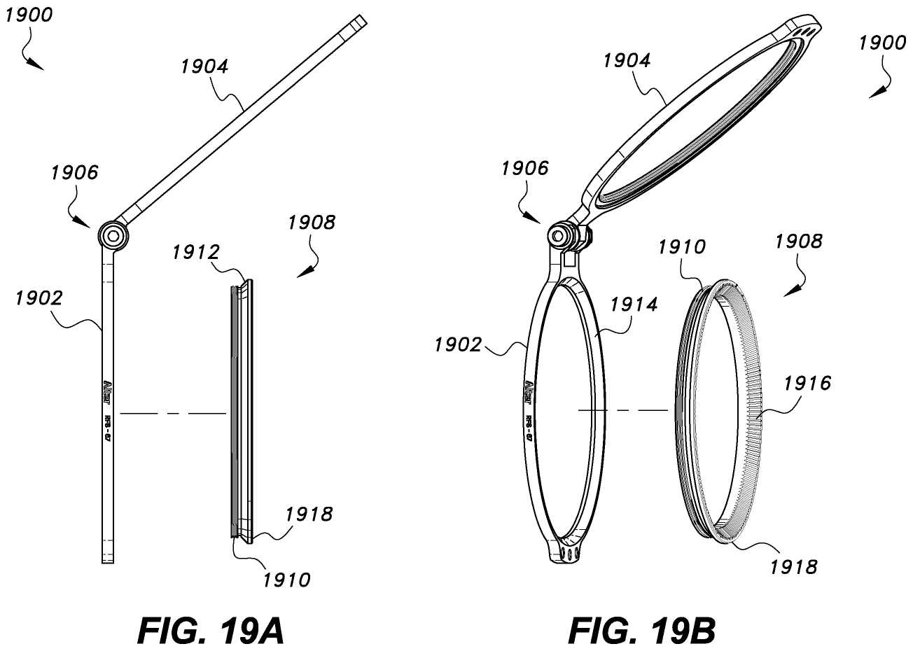

A fourth embodiment of the hinged filter attachment for a photographic lens 1900 is shown in FIGS. 19A and 19B. Similarly to the third embodiment of the hinged filter attachment 1000, the hinged filter attachment 1900 includes a first ring shaped component 1902, a second ring shaped component 1904, a pre-tensioned friction hinge 1906 and a third ring shaped component 1908. Similarly to the third ring-shaped component 1005 described above, the third ring-shaped component 1908 includes external universal threads 1910 that mate with the universal internal threads (see LT in FIG. 1B) provided on most photographic lens. The third ring-shaped component 1908 also includes a convex frustoconical surface 1912 that engages a concave frustoconical surface 1914 on the first ring-shaped component 1902. To mount the hinged filter attachment 1900 to a camera lens, the third ring-shaped component 1908 is screwed onto the camera lens through the center of the first ring-shaped component 1902, until the convex frustoconical surface 1910 engages the concave frustoconical surface 1914 on the first ring-shaped component 1902. Once attached, the first ring-shaped component 1902 and the second ring-shaped component 1904 are rotated until the hinge 1906 is in the desired position. The third ring-shaped component 1908 is then tightened onto the lens to clamp the first ring-shaped component 1902 between the front surface (FS in FIG. 1B) of the lens and the convex frustoconical surface 1910 of the third ring-shaped component 1908, thereby locking it in the desired position. As opposed to the first tool engaging bore 1024 and the second tool engaging bore 1026 of the third ring-shaped component 1005, the third ring-shaped component 1908 includes a friction enhanced or knurled slanted surface 1916 to provide friction for tightening and loosening the third ring-shaped component 1908 by hand. While the knurled slanted surface 1916 is shown as including a number of small ridges, other raised shapes may be used to increase the friction of the surface 1916. This embodiment eliminates the need for an additional tool. The third ring-shaped component 1908 also includes a light skirt 1918 which prevents light from entering between the first ring-shaped component 1902 and the second ring-shaped component 1904 (and therefore between the camera lens L and the filter disc F), when the hinged filter attachment 1900 is in the closed position.

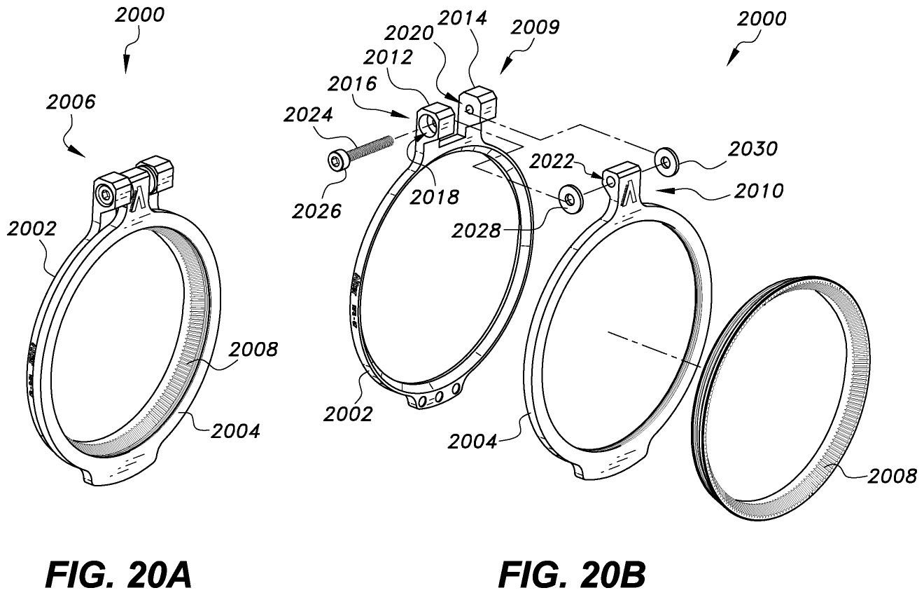

A fifth embodiment of the hinged filter attachment for a photographic lens 2000 is shown in FIGS. 20A and 20B. Similarly to the third 1000 and fourth 1900 embodiments of the hinged filter attachment, the hinged filter attachment 2000 includes a first ring shaped component 2002, a second ring shaped component 2004, a pre-tensioned friction hinge 2006 and a third ring shaped component 2008. The pre-tensioned friction hinge 2006 of the fifth embodiment of the hinged filter attachment 2000 includes a construction that reduces the number of components required, while still providing a pre-tensioned friction hinge. The pre-tensioned friction hinge 2006 includes an outer hinge element 2009 that is attached to the first ring-shaped component 2002 and an inner hinge element 2010 that is attached to the second ring-shaped component 2004. The outer hinge element 2009 includes a first hinge arm 2012 and a second hinge arm 2014. The first hinge arm 2012 includes a through-bore 2016 with an outer increased diameter portion 2018. The second hinge arm 2014 includes a threaded bore 2020. The inner hinge element 2010 includes a through-bore 2022. A hinge pin in the form of a screw 2024 with an enlarged head 2026, extends through the through-bore 2016 of the first hinge arm 2012, a first washer 2028, the through-bore 2022 of the inner hinge element 2010, a second washer 2030 and is screwed into the threaded bore 2020 of the second hinge arm 2014. When the screw 2024 is fully installed, the enlarged head 2026 is recessed within the outer increased diameter portion 2018 of the through-bore 2016, as shown in FIG. 20A. As with the previous embodiments, the pre-tensioned friction hinge 2006 holds the second ring-shaped component 2004 in any position or angle relative to the first ring-shaped component 2002, from parallel (0°) when closed to perpendicularly facing rearward (270°) when fully opened. The washers 2028 and 2030 may be plastic or metal.

It should be noted that all of the features shown with respect to the various embodiments of the hinged filter attachment for a photographic lens can be used with the other embodiments where physically possible.

It is to be understood that the hinged filter attachment for a photographic lens is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A hinged filter attachment for a photographic lens, comprising:
a first ring-shaped component having a front surface, a first side, a second opposite side and external threads that mate with internal threads on a camera lens;
a second ring-shaped component having a rear surface, a first side, a second opposite side and internal threads that mate with external threads on a filter disc; and
a hinge rotatably connecting the first ring-shaped component to the second ring-shaped component.

2. The hinged filter attachment for a photographic lens according to claim 1, wherein the rotational position between the first ring-shaped component and the second ring-shaped component can be adjusted to a desired rotational position between 0° in a closed position to 270° when the hinged filter attachment is in a fully-opened position.

3. The hinged filter attachment for a photographic lens according to claim 2, wherein the hinge is a pre-tensioned friction hinge that maintains the desired rotational position between the first ring-shaped component and the second ring-shaped component.

4. The hinged filter attachment for a photographic lens according to claim 3, wherein the pre-tensioned friction hinge comprises:
an outer hinge element having a first hinge arm and a second hinge arm; and
an inner hinge element; wherein:
the inner hinge element is compressed between the first hinge arm and the second hinge arm to thereby maintain the desired rotational position between the first ring-shaped component and the second ring-shaped component.

5. The hinged filter attachment for a photographic lens according to claim 1, further comprising:
at least one first magnet on the front surface of the first ring-shaped component adjacent to the second side of the first ring-shaped component; and
at least one second magnet on the rear surface of the second ring-shaped component adjacent to the second side of the second ring-shaped component, wherein:
the hinge is attached to the first side of the first ring-shaped component and the first side of the second ring-shaped component.

6. The hinged filter attachment for a photographic lens according to claim 5, wherein:
the at least one first magnet comprises a plurality of first magnets; and
the at least one second magnet comprises a plurality of second magnets.

7. The hinged filter attachment for a photographic lens according to claim 1, wherein the first ring-shaped component further includes a light skirt which prevents light from entering between the first ring-shaped component and the second ring-shaped component, when the hinged filter attachment is in a closed position.

8. A hinged filter attachment for a photographic lens, comprising:
a first ring-shaped component having a front surface, a first side, a second opposite side and a concave frustoconical surface;
a second ring-shaped component having a rear surface, a first side, a second opposite side and internal threads that mate with external threads on a filter disc;
a third ring-shaped component having external threads that mate with internal threads on a camera lens and a convex frustoconical surface that engages the concave frustoconical surface on the first ring-shaped component; and
a hinge rotatably connecting the first ring-shaped component to the second ring-shaped component.

9. The hinged filter attachment for a photographic lens according to claim 8, wherein the rotational position between the first ring-shaped component and the second ring-shaped component can be adjusted to a desired rotational position between 0° in a closed position to 270° when the hinged filter attachment is in a fully-opened position.

10. The hinged filter attachment for a photographic lens according to claim 9, wherein the hinge is a pre-tensioned friction hinge that maintains the desired rotational position between the first ring-shaped component and the second ring-shaped component.

11. The hinged filter attachment for a photographic lens according to claim 10, wherein the pre-tensioned friction hinge comprises:
an outer hinge element having a first hinge arm and a second hinge arm; and
an inner hinge element; wherein:
the inner hinge element is compressed between the first hinge arm and the second hinge arm to thereby maintain the desired rotational position between the first ring-shaped component and the second ring-shaped component.

12. The hinged filter attachment for a photographic lens according to claim 8, further comprising:
at least one first magnet on the front surface of the first ring-shaped component adjacent to the second side of the first ring-shaped component; and
at least one second magnet on the rear surface of the second ring-shaped component adjacent to the second side of the second ring-shaped component, wherein:
the hinge is attached to the first side of the first ring-shaped component and the first side of the second ring-shaped component.

13. The hinged filter attachment for a photographic lens according to claim 12, wherein:
the at least one first magnet comprises a plurality of first magnets; and
the at least one second magnet comprises a plurality of second magnets.

14. The hinged filter attachment for a photographic lens according to claim 8, wherein the third ring-shaped component further includes a light skirt which prevents light from entering between the first ring-shaped component and the second ring-shaped component, when the hinged filter attachment is in a closed position.

15. The hinged filter attachment for a photographic lens according to claim 8, wherein the third ring-shaped component further includes a friction enhanced slanted surface to provide friction for tightening and loosening the third ring-shaped component.

16. The hinged filter attachment for a photographic lens according to claim 12, wherein the friction enhanced slanted surface is a knurled surface.

17. The hinged filter attachment for a photographic lens according to claim 8, wherein the first ring-shaped component can be rotated to position the hinge at any location from 0° to 360° relative to a top of the camera lens.
